(19) United States
(12) Patent Application Publication
(10) Pub. No.: US 2026/0092188 A1
(43) Pub. Date: Apr. 2, 2026

(54) Radiation Curable Ink Composition For Ink Jet And Ink Jet Recording Method

(71) Applicant: SEIKO EPSON CORPORATION, Tokyo (JP)

(72) Inventors: Yusuke FUJISAWA, Shiojiri (JP); Tomoki MIMURA, Matsumoto (JP)

(21) Appl. No.: 19/341,054

(22) Filed: Sep. 26, 2025

(30) Foreign Application Priority Data
Sep. 27, 2024 (JP) 2024-168296

(51) Int. Cl. C09D 11/38; C08K 5/138; C09D 11/322

(52) U.S. Cl. CPC C09D 11/38; C08K 5/138; C09D 11/322

(57) ABSTRACT

There is provided a radiation curable ink composition for ink jet, which contains a polymerizable compound, a polymerization initiator, and a thioxanthone sensitizing agent having a molecular weight of 300 or more, in which the polymerizable compound includes a monofunctional polymerizable compound and a difunctional polymerizable compound, the polymerization initiator includes phenyl bis(2,4,6-trimethylbenzoyl)phosphine oxide, the monofunctional polymerizable compound includes a hydroxyl group-containing monofunctional polymerizable compound, and a content of the difunctional polymerizable compound is 30% by mass or more with respect to a total amount of the ink composition.

The present application is based on, and claims priority from JP Application Serial Number 2024-168296, filed Sep. 27, 2024, the disclosure of which is hereby incorporated by reference herein in its entirety.

### BACKGROUND

### 1. Technical Field

The present disclosure relates to a radiation curable ink composition for ink jet and an ink jet recording method.

### 2. Related Art

An ink jet recording method can record a high-definition image with a relatively simple apparatus and is rapidly developed in various fields. In such a process of development, various studies are being made on the radiation curable ink composition for ink jet. For example, JP-A-2024-20850 discloses a photocurable ink composition for ink jet that contains, in order to reduce a migration risk, a thioxanthone-based compound having a photosensitizing action, an ethylenic unsaturated bond-containing polymeric photopolymerization initiator, a (meth)acrylate-based compound, a (meth)acrylic acid amide-based compound and/or an aminobenzoate compound, and a surface adjusting agent, and has a specific viscosity and a specific surface tension.

However, in a case where printing is carried out using the photocurable ink composition for ink jet described in JP-A-2024-20850, there is a problem in that it is difficult to improve the curability of the coating film of the ink and the abrasion resistance of the coating film. That is, there is a demand for a radiation curable ink composition for ink jet which has excellent curability of the coating film of the ink and excellent abrasion resistance of the coating film while reducing the migration risk.

### SUMMARY

According to an aspect of the present disclosure, a radiation curable ink composition for ink jet contains a hydroxyl group-containing monofunctional polymerizable compound, a difunctional polymerizable compound, a thioxanthone sensitizing agent having a molecular weight of 300 or more, and a polymerization initiator, where the polymerization initiator includes phenyl bis(2,4,6-trimethylbenzoyl)phosphine oxide, and a content of the difunctional polymerizable compound is 30% by mass or more with respect to a total amount of the ink composition.

### BRIEF DESCRIPTION OF THE DRAWINGS

FIG. 1 is a schematic view of a recording apparatus that is used in the present embodiment.

FIG. 2 is a table showing the composition and evaluation results of the ink composition according to examples.

FIG. 3 is a table showing the composition and evaluation results of the ink compositions according to examples and comparative examples.

### DESCRIPTION OF EMBODIMENTS

Hereinafter, an embodiment of the present disclosure (hereinafter, referred to as “the present embodiment”) will be described in detail; however, the present disclosure is not limited thereto, and various modifications can be made to the extent that the gist thereof is maintained. In the following description, the radiation curable ink composition for ink jet may be simply referred to as an “ink composition”.

### 1. Radiation Curable Ink Composition for Ink Jet

A radiation curable ink composition for ink jet according to the present embodiment contains a hydroxyl group-containing monofunctional polymerizable compound, a difunctional polymerizable compound, a thioxanthone sensitizing agent having a molecular weight of 300 or more, and a polymerization initiator, where the polymerization initiator includes phenyl bis(2,4,6-trimethylbenzoyl)phosphine oxide, and a content of the difunctional polymerizable compound is 30% by mass or more with respect to a total amount of the ink composition.

By containing a thioxanthone sensitizing agent having a molecular weight of 300 or more, it is possible to reduce the migration risk in the coating film of the ink composition. However, in this case, the coating film of the ink composition does not have sufficient curability, which is a problem to be solved.

Therefore, the coating film of the ink composition has excellent curability by containing phenyl bis(2,4,6-trimethylbenzoyl)phosphine oxide having excellent curability, and further containing a hydroxyl group-containing monofunctional polymerizable compound having excellent compatibility with a thioxanthone sensitizing agent.

Further, an ink composition containing a thioxanthone sensitizing agent having a molecular weight of 300 or more, phenyl bis(2,4,6-trimethylbenzoyl)phosphine oxide, and a hydroxyl group-containing monofunctional polymerizable compound tends to be difficult to improve the abrasion resistance of the coating film of the ink composition. Therefore, the coating film of the ink composition has excellent abrasion resistance by containing 30% by mass or more of the difunctional polymerizable compound with respect to the total amount of the ink composition.

Hereinafter, each component of the radiation curable ink composition for ink jet according to the present embodiment will be described in detail

### 1.1. Polymerizable Compound

The ink composition according to the present embodiment contains a polymerizable compound. The concept of the polymerizable compound includes a monofunctional polymerizable compound having one polymerizable functional group and a polyfunctional polymerizable compound having two or more polymerizable functional groups. In a case where the ink composition according to the present embodiment is irradiated with actinic rays, the polymerization reaction of the polymerizable compound contained in the ink composition is initiated, and the ink composition is cured. The polymerizable compound includes a monomer and an oligomer. One kind of polymerizable compound is used alone, or two or more kinds thereof are used in combination.

It is noted that, in the present embodiment, the degree of polymerization of the monomer in the oligomer is not particularly limited; however, it is, for example, 2 or more and 100 or less, 2 or more and 50 or less, 2 or more and 25 or less, 2 or more and 10 or less, or 2 to 5. The degree of polymerization referred to here indicates the number of monomers constituting the oligomer.

The content of the polymerizable compound is preferably 60% by mass or more and 95% by mass or less, 65% by mass or more and 90% by mass or less, or 70% by mass or more and 90% by mass or less, with respect to the total amount of the ink composition.

In the radiation curable ink composition for ink jet according to the present embodiment, the weighted average of the glass transition temperature of the polymerizable compound to be contained is more preferably 30° C. or higher and 70° C. or lower, and still more preferably 35° C. or higher and 65° C. or lower.

Here, “the weighted average of the glass transition temperature of the polymerizable compound to be contained” is determined as follows. The glass transition temperature of each polymerizable compound contained in the radiation curable ink composition for ink jet is the glass transition temperature of each homopolymer of each polymerizable compound. In addition, a temperature obtained by proportionally dividing the glass transition temperature of each polymerizable compound at a proportion of the mass to be contained is defined as “the weighted average of the glass transition temperature of the polymerizable compound to be contained”. That is, “the weighted average of the glass transition temperature of the polymerizable compound to be contained” is defined as a value calculated by setting the total mass of all of the polymerizable compounds contained in the radiation curable ink composition for ink jet to 100% by mass and weighting the glass transition temperature of each polymerizable compound according to the proportion (% by mass) occupied by each polymerizable compound.

Here, a calculation method for the weighted average of the glass transition temperature in the polymerizable compound will be described. The value of the weighted average of the glass transition temperature is denoted as Tg_{All}, the glass transition temperature of the homopolymer of each polymerizable compound is denoted as Tg_{N}, and the mass ratio of the polymerizable compound is denoted as X_{N} (wt %). For the number N, numbers are entered in order, starting from 1, depending on the kind of the polymerizable compound contained in the radiation curable ink composition for ink jet. For example, in a case where three kinds of polymerizable compounds are used, Tg₁, Tg₂, and Tg₃ are generated. The weighted average Tg_{A}ml of the glass transition temperature of the homopolymer is the sum of the products of the glass transition temperature Tg_{N} of the homopolymer calculated for each polymerizable compound and the mass ratio X_{N} of the monomer. As a result, Expression (1) is established.

$${Tg}_{All} = \sum {Tg}_{N} \times {X}_{N} \qquad ( 1 )$$

In a case where the weighted average of the glass transition temperature of the polymerizable compound to be contained is 30° C. or higher and 70° C. or lower, a recorded matter having further excellent blocking properties and shrinkage characteristics is easily obtained. As the glass transition temperature is higher, the coating film and the recording medium are less likely to stick, and thus the blocking properties are excellent. In addition, as the glass transition temperature is lower, the flexibility of the coating film is increased, and the shrinkage characteristics are excellent.

In addition, in the radiation curable ink composition for ink jet according to the present embodiment, the monofunctional polymerizable compound is contained such that the content thereof is preferably 50% by mass or more, more preferably 55% by mass or more, and still more preferably 60% by mass or more, with respect to the total mass of the polymerizable compound to be contained. In such a case, the curability of the composition and the anti-blocking properties of the coating film can be further improved.

### 1.1.1. Monofunctional Polymerizable Compound

The ink composition according to the present embodiment contains a monofunctional polymerizable compound. Examples of the monofunctional polymerizable compound include a hydroxyl group-containing monofunctional polymerizable compound, a nitrogen-containing heterocyclic ring-containing monofunctional polymerizable compound, a monofunctional polymerizable compound having an alicyclic structure, and an aromatic group-containing monofunctional polymerizable compound. It is noted that in a case where the term “monofunctional” is used, it is assumed that the number of functional groups of the polymerizable double bond is one. One kind of polymerizable compound is used alone, or two or more kinds thereof are used in combination.

The total amount of the monofunctional polymerizable compound is preferably 5.0% by mass or more and 70.0% by mass or less, 5.0% by mass or more and 60.0% by mass or less, 10.0% by mass or more and 50.0% by mass or less, or 15.0% by mass or more and 45.0% by mass or less, with respect to the total amount of the ink composition. In a case where the content of the monofunctional polymerizable compound is within the above-described range, the curability and flexibility of the coating film of the ink composition are excellent. Specifically, the total amount of the monofunctional polymerizable compound is 5.0%, 10.0%, 15.0%, 20.0%, 25.0%, 30.0%, 35.0%, 40.0%, 45.0%, 50.0%, 55.0%, 60.0%, 65.0%, or 70.0% by mass with respect to the total amount of the polymerizable compound, and it may be within a range between any two of these numerical values.

The total amount of the monofunctional polymerizable compound is preferably 5.0% by mass or more and 75.0% by mass or less, 5.0% by mass or more and 60.0% by mass or less, 10.0% by mass or more and 55.0% by mass or less, or 15.0% by mass or more and 45.0% by mass or less, with respect to the total amount of the polymerizable compound. In a case where the content of the monofunctional polymerizable compound is within the above-described range, the curability and flexibility of the coating film of the ink composition tend to be excellent.

### 1.1.1.1. Hydroxyl Group-Containing Monofunctional Polymerizable Compound

The ink composition according to the present embodiment contains a hydroxyl group-containing monofunctional polymerizable compound. As a result, sufficient curability can be obtained even in a case where the ink composition according to the present embodiment contains a thioxanthone sensitizing agent having a molecular weight of 300 or more, which will be described later, and phenyl bis(2,4,6-trimethylbenzoyl)phosphine oxide. Regarding the factors for improving the curability of the ink composition, it is considered to be because the thioxanthone sensitizing agent having a molecular weight of 300 or more and phenyl bis(2,4,6-trimethylbenzoyl)phosphine oxide have high compatibility with a hydroxyl group-containing monofunctional polymerizable compound, and thus the curing reaction of the ink composition reacts more quickly.

The hydroxyl group-containing monofunctional polymerizable compound is not particularly limited as long as it is a monofunctional polymerizable compound containing a hydroxyl group; however, from the viewpoint of further improving curability, it is preferable to include, for example, 4-hydroxybutyl (meth)acrylate, 1,4-cyclohexanedimethanol monoacrylate, 2-hydroxy-3-phenoxypropyl (meth)acrylate, 2-hydroxyethyl (meth)acrylate, 2-hydroxypropyl (meth)acrylate, 2-hydroxy-3-phenoxypropyl (meth)acrylate, and 2-hydroxyethyl (meth)acrylate. In particular, it is more preferable to include 4-hydroxybutyl (meth)acrylate, 1,4-cyclohexanedimethanol monoacrylate, and 2-hydroxy-3-phenoxypropyl (meth)acrylate from the viewpoint of improving curability. The ink composition may contain one kind of hydroxyl group-containing monofunctional polymerizable compound or may contain two or more kinds of hydroxyl group-containing monofunctional polymerizable compounds.

In the present specification, “(meth)acrylate” means at least any of acrylate and methacrylate corresponding to acrylate, and “(meth)acrylic” means at least any of acrylic and methacrylic corresponding to acrylic.

The content of the hydroxyl group-containing monofunctional polymerizable compound is preferably 2.0% by mass or more and 50.0% by mass or less, 3.0% by mass or more and 45.0% by mass or less, 5.0% by mass or more and 40.0% by mass or less, 10.0% by mass or more and 37.5% by mass or less, or 12.5% by mass or more and 35.0% by mass or less, with respect to the total amount of the ink composition. In a case where the content of the hydroxyl group-containing monofunctional polymerizable compound is within the above-described range, the curability tends to be further improved. Specifically, the content of the hydroxyl group-containing monofunctional polymerizable compound is 2.0%, 5.0%, 10.0%, 12.5%, 15.0%, 20.0%, 25.0%, 30.0%, 35.0%, 37.5%, 40.0%, 45.0%, or 50% by mass, and it may be within a range between any two of these numerical values.

The content of the hydroxyl group-containing monofunctional polymerizable compound is preferably 2.0% by mass or more and 60.0% by mass or less, 5.0% by mass or more and 50.0% by mass or less, or 10.0% by mass or more and 40.0% by mass or less, with respect to the total amount of the polymerizable compound. In a case where the content of the hydroxyl group-containing monofunctional polymerizable compound is within the above-described range, the curability tends to be further improved.

The content of the hydroxyl group-containing monofunctional polymerizable compound is preferably 2.0% by mass or more and 60.0% by mass or less, 5.0% by mass or more and 50.0% by mass or less, or 10.0% by mass or more and 40.0% by mass or less, with respect to the total amount of the monofunctional polymerizable compound. In a case where the content of the hydroxyl group-containing monofunctional polymerizable compound is within the above-described range, the curability tends to be further improved.

### 1.1.1.2. Nitrogen-Containing Heterocyclic Ring-Containing Monofunctional Polymerizable Compound

The ink composition according to the present embodiment may contain a nitrogen-containing heterocyclic ring-containing monofunctional polymerizable compound. As a result, the curability tends to be excellent.

The ink composition according to the present embodiment preferably contains a nitrogen-containing heterocyclic ring-containing monofunctional polymerizable compound containing a vinyl group or a nitrogen-containing heterocyclic ring-containing monofunctional polymerizable compound containing an oxazolidinone group as the nitrogen-containing heterocyclic ring-containing monofunctional polymerizable compound. In particular, it is more preferable to contain N-vinylmethyl oxazolidinone (VMOX) or acryloyl morpholine (ACMO). In a case where the ink composition according to the present embodiment contains VMOX or ACMO, the curability of the ink composition tends to be further improved.

In addition, the ink composition according to the present embodiment may contain a nitrogen-containing heterocyclic ring-containing monofunctional polymerizable compound other than VMOX and ACMO. The nitrogen-containing heterocyclic ring-containing monofunctional polymerizable compound other than VMOX and ACMO is not particularly limited. However, examples thereof include nitrogen-containing monofunctional vinyl monomers such as N-vinylcaprolactam, N-vinylformamide, N-vinylcarbazole, N-vinylacetamide, and N-vinylpyrrolidone; nitrogen-containing monofunctional acrylate monomers such as N-(2-hydroxyethyl)acrylamide; nitrogen-containing monofunctional acrylamide monomers such as (meth)acrylamides such as (meth)acrylamide, N-hydroxymethyl (meth)acrylamide, diacetone acrylamide, N,N-dimethyl (meth)acrylamide, and a dimethylaminoethyl acrylate benzyl chloride quaternary salt; and oligomers thereof. Regarding the nitrogen-containing heterocyclic ring-containing monofunctional polymerizable compound, one kind thereof may be contained, or two or more kinds thereof may be contained.

The content of the nitrogen-containing heterocyclic ring-containing monofunctional polymerizable compound is preferably 10% by mass or more and 50% by mass or less, 15% by mass or more and 45% by mass or less, 20% by mass or more and 40% by mass or less, or 20% by mass or more and 35% by mass or less, with respect to the total amount of the ink composition. In a case where the content of the nitrogen-containing heterocyclic ring-containing monofunctional polymerizable compound with respect to the total amount of the ink composition is within the above-described range, the curability of the ink composition tends to be further improved. Specifically, the content of the nitrogen-containing heterocyclic ring-containing monofunctional polymerizable compound is 0.0%, 5.0%, 10.0%, 12.5%, 15.0%, 20.0%, 25.0%, 30.0%, 35.0%, 37.5%, 40.0%, 45.0%, or 50% by mass, and it may be within a range between any two of these numerical values.

The content of the nitrogen-containing heterocyclic ring-containing monofunctional polymerizable compound is preferably 15% by mass or more and 55% by mass or less, 20% by mass or more and 50% by mass or less, 25% by mass or more and 45% by mass or less, or 25% by mass or more and 40% by mass or less, with respect to the total amount of the polymerizable compound. In a case where the content of the nitrogen-containing heterocyclic ring-containing monofunctional polymerizable compound with respect to the total amount of the polymerizable compound is within the above-described range, the curability of the ink composition tends to be further improved.

The content of the nitrogen-containing heterocyclic ring-containing monofunctional polymerizable compound is preferably 20% by mass or more and 65% by mass or less, 25% by mass or more and 60% by mass or less, or 30% by mass or more and 55% by mass or less, with respect to the total amount of the monofunctional polymerizable compound. In a case where the content of the nitrogen-containing heterocyclic ring-containing monofunctional polymerizable compound with respect to the total amount of the monofunctional polymerizable compound is within the above-described range, the curability of the ink composition tends to be further improved.

The molecular weight of the nitrogen-containing heterocyclic ring-containing monofunctional polymerizable compound is preferably 100 or more and 200 or less, or 110 or more and 180 or less. In a case where the molecular weight of the nitrogen-containing heterocyclic ring-containing monofunctional polymerizable compound is within the above-described range, the curability of the ink composition tends to be further improved.

The glass transition temperature of the homopolymer of the nitrogen-containing heterocyclic ring-containing monofunctional polymerizable compound is preferably 50° C. or higher and 200° C. or lower, and 100° C. or higher and 175° C. or lower. In a case where the glass transition temperature of the nitrogen-containing heterocyclic ring-containing monofunctional polymerizable compound is within the above-described range, the blocking resistance tends to be further improved.

### 1.1.1.3. Monofunctional Polymerizable Compound Having Alicyclic Structure

The ink composition according to the present embodiment may contain a monofunctional polymerizable compound having an alicyclic structure. The monofunctional polymerizable compound having an alicyclic structure is not particularly limited. However, examples thereof include monomers having a monocyclic hydrocarbon group, such as tert-butylcyclohexanol (meth)acrylate (TBCHA), 3,3,5-trimethylcyclohexyl (meth)acrylate (TMCHA), and 2-(meth)acrylic acid 1,4-dioxaspiro[4,5]dec-2-ylmethyl ester; monomers having an unsaturated polycyclic hydrocarbon group, such as dicyclopentenyl (meth)acrylate and dicyclopentenyloxyethyl (meth)acrylate; and monomers having a saturated polycyclic hydrocarbon group, such as dicyclopentanyl (meth)acrylate and isobornyl (meth)acrylate (IBXA).

Among these, isobornyl (meth)acrylate, tert-butylcyclohexanol acrylate, or trimethylcyclohexyl (meth)acrylate is preferable, and isobornyl acrylate is more preferable. In a case where such a monofunctional polymerizable compound having an alicyclic structure is used, the blocking resistance or the curability tends to be further improved.

In addition, the content of the monofunctional polymerizable compound having an alicyclic structure is preferably 15% by mass or more and 45% by mass or less, more preferably 20% by mass or more and 40% by mass or less, and still more preferably 25% by mass or more and 35% by mass or less, with respect to the total amount of the ink composition. In a case where the content of the monofunctional monomer having an alicyclic structure is within the above-described range, the blocking resistance or the curability tends to be further improved.

In addition, the content of the monofunctional polymerizable compound having an alicyclic structure is preferably 15% by mass or more and 45% by mass or less, 20% by mass or more and 40% by mass or less, or 25% by mass or more and 35% by mass or less, with respect to the total amount of the polymerizable compound. In a case where the content of the monofunctional polymerizable compound having an alicyclic structure is within the above-described range, the blocking resistance or the curability tends to be further improved.

In addition, the content of the monofunctional polymerizable compound having an alicyclic structure is preferably 15% by mass or more and 45% by mass or less, more preferably 20% by mass or more and 40% by mass or less, and still more preferably 25% by mass or more and 35% by mass or less, with respect to the total amount of the monofunctional polymerizable compound. In a case where the content of the monofunctional polymerizable compound having an alicyclic structure is within the above-described range, the blocking resistance or the curability tends to be further improved. Specifically, the content of the monofunctional polymerizable compound having an alicyclic structure is 0.0%, 5.0%, 10.0%, 12.5%, 15.0%, 20.0%, 25.0%, 30.0%, 35.0%, 37.5%, 40.0%, 45.0%, or 50% by mass, and it may be within a range between any two of these numerical values.

### 1.1.1.4. Aromatic Group-Containing Monofunctional Polymerizable Compound

The ink composition according to the present embodiment may contain or may not contain an aromatic group-containing monofunctional polymerizable compound having an aromatic group. The aromatic group-containing monofunctional polymerizable compound is not particularly limited as long as it is a monofunctional polymerizable compound containing an aromatic group. However, examples thereof include phenoxyethyl (meth)acrylate, benzyl (meth)acrylate, an alkoxylated 2-phenoxyethyl (meth)acrylate, an ethoxylated nonylphenyl (meth)acrylate, an alkoxylated nonylphenyl (meth)acrylate, p-cumylphenol EO-modified (meth)acrylate, and 2-hydroxy-3-phenoxypropyl (meth)acrylate. Among them, it is preferable to contain phenoxyethyl (meth)acrylate or benzyl (meth)acrylate from the viewpoint of further improving the low-temperature storage stability.

The content of the aromatic group-containing monofunctional polymerizable compound is preferably 0.0% by mass or more and 40.0% by mass or less, 3.0% by mass or more and 35.0% by mass or less, 5.0% by mass or more and 30.0% by mass or less, or 10.0% by mass or more and 25.0% by mass or less, with respect to the total amount of the ink composition. In a case where the content of the aromatic group-containing monofunctional polymerizable compound is within the above-described range, the low-temperature storage stability tends to be further improved. Specifically, the content of the aromatic group-containing monofunctional polymerizable compound is 0.0%, 5.0%, 10.0%, 15.0%, 20.0%, 25.0%, 30.0%, 35.0%, or 40.0% by mass, and it may be within a range between any two of these numerical values.

The content of the aromatic group-containing monofunctional polymerizable compound is preferably 0.0% by mass or more and 40.0% by mass or less, 3.0% by mass or more and 35.0% by mass or less, 5% by mass or more and 30.0% by mass or less, or 10.0% by mass or more and 27.5% by mass or less, with respect to the total amount of the polymerizable compound. In a case where the content of the aromatic group-containing monofunctional polymerizable compound is within the above-described range, the low-temperature storage stability tends to be further improved. Specifically, the content of the aromatic group-containing monofunctional polymerizable compound may be 0.0%, 5.0%, 10.0%, 15.0%, 20.0%, 25.0%, 30.0%, 35.0%, or 40.0% by mass, and it may be within a range between any two of these numerical values.

The content of the aromatic group-containing monofunctional polymerizable compound is preferably 0.0% by mass or more and 40.0% by mass or less, 3.0% by mass or more and 35.0% by mass or less, 5% by mass or more and 30.0% by mass or less, or 10.0% by mass or more and 27.5% by mass or less, with respect to the total amount of the monofunctional polymerizable compound. In a case where the content of the aromatic group-containing monofunctional polymerizable compound is within the above-described range, the low-temperature storage stability tends to be further improved. Specifically, the content of the aromatic group-containing monofunctional polymerizable compound may be 0.0%, 5.0%, 10.0%, 15.0%, 20.0%, 25.0%, 30.0%, 35.0%, or 40.0% by mass, and it may be within a range between any two of these numerical values.

### 1.1.2. Polyfunctional Polymerizable Compound

The polyfunctional polymerizable compound in the present embodiment includes a difunctional polymerizable compound having two polymerizable functional groups and a tri- or higher functional polymerizable compound having three or more polymerizable functional groups.

### 1.1.2.1. Difunctional Polymerizable Compound

In the present embodiment, the ink composition contains a difunctional polymerizable compound. The difunctional polymerizable compound is not particularly limited. However, examples thereof include diethylene glycol di(meth)acrylate, dipropylene glycol di(meth)acrylate, acrylic acid 2-(2-vinyloxyethoxy)ethyl ester, triethylene glycol di(meth)acrylate, tetraethylene glycol di(meth)acrylate, polyethylene glycol di(meth)acrylate, tripropylene glycol di(meth)acrylate, polypropylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dimethylol-tricyclodecane di(meth)acrylate, an ethylene oxide (EO) adduct di(meth)acrylate of bisphenol A, a propylene oxide (PO) adduct di(meth)acrylate of bisphenol A, hydroxypivalic acid neopentyl glycol di(meth)acrylate ester, and polytetramethylenglycol di(meth)acrylate. One kind of these difunctional polymerizable compounds is used alone, or two or more kinds thereof are used in combination. It is noted that in a case where the term “difunctional” is referred to, it means that the number of functional groups of the polymerizable double bond is 2.

Among them, in a case where any one or more of dipropylene glycol di(meth)acrylate, acrylic acid 2-(2-vinyloxyethoxy)ethyl ester, and 1,6-hexanediol di(meth)acrylate are contained, the ink coating film tends to have more excellent abrasion resistance, which is more preferable.

The difunctional polymerizable compound may include a compound represented by Formula (1), such as acrylic acid 2-(2-vinyloxyethoxy)ethyl ester. In a case where such a vinyl ether group-containing (meth)acrylate is contained, the viscosity of the ink composition tends to decrease, and the eject stability tends to be further improved. In addition, the curability of the ink composition is further improved, and the recording speed can also be further increased as the curability is improved.

CH₂═CR¹—COOR²—O—CH═CH—R³ (1)

(In Formula (1), R¹ is a hydrogen atom or a methyl group, R² is a divalent organic residue having 2 to 20 carbon atoms, and R³ is a hydrogen atom or a monovalent organic residue having 1 to 11 carbon atoms.)

In Formula (1) described above, examples of the divalent organic residue having 2 to 20 carbon atoms which is represented by R² include a linear, branched, or cyclic alkylene group having 2 to 20 carbon atoms, which may be substituted, a alkylene group having 2 to 20 carbon atoms and having an oxygen atom due to an ether bond and/or an ester bond in the structure, which may be substituted, a divalent aromatic group having 6 to 11 carbon atoms, which may be substituted. Among these, an alkylene group having 2 to 6 carbon atoms, such as an ethylene group, an n-propylene group, an isopropylene group, or a butylene group, or an alkylene group having 2 to 9 carbon atoms such as an oxyethylene group, an oxy n-propylene group, an oxyisopropylene group, or an oxybutylene group, which has an oxygen atom due to an ether bond in the structure, is preferable. Further, from the viewpoint of further lowering the viscosity of the composition and further improving the curability of the composition, a compound containing a glycol ether chain, in which R² is an alkylene group having 2 to 9 carbon atoms, where R² has an oxygen atom due to an ether bond in the structure, such as an oxyethylene group, an oxy n-propylene group, an oxyisopropylene group, or an oxybutylene group, is more preferable.

In Formula (1) described above, as the monovalent organic residue having 1 to 11 carbon atoms which is represented by R³, a linear, branched, or cyclic alkyl group having 1 to 10 carbon atoms, which may be substituted, or an aromatic group having 6 to 11 carbon atoms, which may be substituted is suitable. Among these, an alkyl group having 1 to 2 carbon atoms, which is a methyl group or an ethyl group, or an aromatic group having 6 to 8 carbon atoms, such as a phenyl group or a benzyl group, is suitably used.

In a case where each of the above-described organic residues is a group which may be substituted, the substituent thereof is divided into a group that contains a carbon atom and a group that does not contain a carbon atom. First, in a case where the substituent is a group containing a carbon atom, the carbon atom is counted to be included in the number of carbon atoms in the organic residue. Although the group containing a carbon atom is not limited to the following groups, examples thereof include a carboxyl group and an alkoxy group. Next, although the group that does not contain a carbon atom is not limited to the following groups, examples thereof include a hydroxyl group and a halogen group.

Specific examples of the compound of Formula (1) are not particularly limited. However, examples thereof include (meth)acrylic acid 2-vinyloxyethyl ester, (meth)acrylic acid 3-vinyloxypropyl ester, (meth)acrylic acid 1-methyl-2-vinyloxyethyl ester, (meth)acrylic acid 2-vinyloxypropyl ester, (meth)acrylic acid 4-vinyloxybutyl ester, (meth)acrylic acid 1-methyl-3-vinyloxypropyl ester, (meth)acrylic acid 1-vinyloxymethylpropyl ester, (meth)acrylic acid 2-methyl-3-vinyloxypropyl ester, (meth)acrylic acid 1,1-dimethyl-2-vinyloxyethyl ester, (meth)acrylic acid 3-vinyloxybutyl ester, (meth)acrylic acid 1-methyl-2-vinyloxypropyl ester, (meth)acrylic acid 2-vinyloxybutyl ester, (meth)acrylic acid 4-vinyloxycyclohexyl ester, (meth)acrylic acid 6-vinyloxyhexyl ester, (meth)acrylic acid 4-vinyloxymethylcyclohexylmethyl ester, (meth)acrylic acid 3-vinyloxymethylcyclohexylmethyl ester, (meth)acrylic acid 2-vinyloxymethylcyclohexylmethyl ester, (meth)acrylic acid p-vinyloxymethylphenylmethyl ester, (meth)acrylic acid m-vinyloxymethylphenylmethyl ester, (meth)acrylic acid o-vinyloxymethylphenylmethyl ester, methacrylic acid 2-(2-vinyloxyethoxy)ethyl ester, acrylic acid 2-(2-vinyloxyethoxy)ethyl ester, (meth)acrylic acid 2-(vinyloxyisopropoxy)ethyl ester, (meth)acrylic acid 2-(vinyloxyethoxy)propyl ester, (meth)acrylic acid 2-(vinyloxyethoxy)isopropyl ester, (meth)acrylic acid 2-(vinyloxyisopropoxy)propyl ester, (meth)acrylic acid 2-(vinyloxyisopropoxy)isopropyl ester, (meth)acrylic acid 2-(vinyloxyethoxyethoxy)ethyl ester, (meth)acrylic acid 2-(vinyloxyethoxyisopropoxy)ethyl ester, (meth)acrylic acid 2-(vinyloxyisopropoxyethoxy)ethyl ester, (meth)acrylic acid 2-(vinyloxyisopropoxyisopropoxy)ethyl ester, (meth)acrylic acid 2-(vinyloxyethoxyethoxy)propyl ester, (meth)acrylic acid 2-(vinyloxyethoxyisopropoxy)propyl ester, (meth)acrylic acid 2-(vinyloxyisopropoxyethoxy)propyl ester, (meth)acrylic acid 2-(vinyloxyisopropoxyisopropoxy)propyl ester, (meth)acrylic acid 2-(vinyloxyethoxyethoxy)isopropyl ester, (meth)acrylic acid 2-(vinyloxyethoxyisopropoxy)isopropyl ester, (meth)acrylic acid 2-(vinyloxyisopropoxyethoxy)isopropyl ester, (meth)acrylic acid 2-(vinyloxyisopropoxyisopropoxy)isopropyl ester, (meth)acrylic acid 2-(vinyloxyethoxyethoxyethoxy)ethyl ester, (meth)acrylic acid 2-(vinyloxyethoxyethoxyethoxyethoxyethoxy)ethyl ester, (meth)acrylic acid 2-(isopropenoxyethoxy)ethyl ester, (meth)acrylic acid 2-(isopropenoxyethoxyethoxy)ethyl ester, (meth)acrylic acid 2-(isopropenoxyethoxyethoxyethoxy)ethyl ester, (meth)acrylic acid 2-(isopropenoxyethoxyethoxyethoxyethoxy)ethyl ester, (meth)acrylic acid polyethylene glycol monovinyl ether ester, and (meth)acrylic acid polypropylene glycol monovinyl ether ester. Among these specific examples, acrylic acid 2-(2-vinyloxyethoxy)ethyl ester is particularly preferable in that the curability and viscosity of the composition can be easily balanced. It is noted that, in the present embodiment, acrylic acid 2-(2-vinyloxyethoxy)ethyl ester may be referred to as VEEA.

The content of the difunctional polymerizable compound is 30% by mass or more with respect to the total amount of the ink composition. The content thereof is preferably 35.0% by mass or more and 90.0% by mass or less, 40.0% by mass or more and 80.0% by mass or less, 45.0% by mass or more and 75.0% by mass or less, or 50.0% by mass or more and 70.0% by mass or less, with respect to the total amount of the ink composition. In a case where the content thereof is within the above-described range, the viscosity characteristics and curability tend to be more excellent. Specifically, the content of the difunctional polymerizable compound may be 30.0%, 35.0%, 40.0%, 45.0%, 50.0%, 55.0%, 60.0%, 65.0%, 70.0%, 75.0%, 80.0%, 85.0%, or 90.0% by mass, and it may be within a range between any two of these numerical values.

The content of the difunctional polymerizable compound is preferably 35.0% by mass or more and 90.0% by mass or less, 40.0% by mass or more and 80.0% by mass or less, 45.0% by mass or more and 75.0% by mass or less, or 50.0% by mass or more and 70.0% by mass or less, with respect to the total amount of the polymerizable compound. In a case where the content thereof is within the above-described range, the viscosity characteristics and curability tend to be more excellent. Specifically, the content of the difunctional polymerizable compound may be 30.0%, 35.0%, 40.0%, 45.0%, 50.0%, 55.0%, 60.0%, 65.0%, 70.0%, 75.0%, 80.0%, 85.0%, or 90.0% by mass, and it may be within a range between any two of these numerical values.

### 1.1.2.2. Tri- or Higher Functional Polymerizable Compound

The ink composition according to the present embodiment may contain or may not contain a tri- or higher functional polyfunctional polymerizable compound. The tri- or higher functional polyfunctional polymerizable compound is not particularly limited; however, examples thereof include trimethylolpropane tri(meth)acrylate, an EO-modified trimethylolpropane tri(meth)acrylate, dipentaerythritol polyacrylate, pentaerythritol tri(meth)acrylate, pentaerythritol tetra(meth)acrylate, an ethoxylated dipentaerythritol polyacrylate, dipentaerythritol hexa(meth)acrylate, ditrimethylolpropane tetra(meth)acrylate, glycerin propoxy tri(meth)acrylate, a caprolactone-modified trimethylolpropane tri(meth)acrylate, pentaerythritol ethoxy tetra(meth)acrylate, and a caprolactam-modified dipentaerythritol hexa(meth)acrylate. It is noted that in a case where the term “tri- or higher functional” is referred to, it means that the number of functional groups of the polymerizable double bond is 3 or more.

The content of the polyfunctional (meth)acrylate which is tri- or higher functional is preferably 0.0% by mass or more and 20.0% by mass or less, 1.5% by mass or more and 15.0% by mass or less, 3.0% by mass or more and 12.5% by mass or less, or 5.0% by mass or more and 10.0% by mass or less, with respect to the total amount of the ink composition. In a case where the content thereof is within the above-described range, the curability tends to be more excellent.

The content of the polyfunctional (meth)acrylate which is tri- or higher functional is preferably 0.0% by mass or more and 20.0% by mass or less, 1.5% by mass or more and 15.0% by mass or less, 3.0% by mass or more and 12.5% by mass or less, or 5.0% by mass or more and 10.0% by mass or less, with respect to the total amount of the polymerizable compound. In a case where the content thereof is within the above-described range, the curability tends to be more excellent.

### 1.2. Polymerization Initiator

The ink composition according to the present embodiment contains a polymerization initiator. In a case where the polymerization initiator is irradiated with actinic rays, the polymerization initiator generates an active species. The generated active species promote a reaction of the polymerizable compound contained in the ink composition. The polymerization initiator includes phenyl bis(2,4,6-trimethylbenzoyl)phosphine oxide. Since phenyl bis(2,4,6-trimethylbenzoyl)phosphine oxide is contained, the curability is excellent even in a case of an ink composition containing a thioxanthone sensitizing agent having a molecular weight of 300 or more, which has a low migration risk. One kind of polymerization initiator is used alone, or two or more kinds thereof are used in combination.

As the polymerization initiator, other polymerization initiators other than phenyl bis(2,4,6-trimethylbenzoyl)phosphine oxide may be contained. The other polymerization initiators are not particularly limited; however, they may include, for example, aromatic ketones, hydroxyketones, an acyl phosphine compound, an aromatic onium salt compound, an organic peroxide, a thio compound such as a thioxanthone-based thio compound, a hexaaryl biimidazole compound, a ketoxime ester compound, a borate compound, an azinium compound, a metallocene compound, an active ester compound, a compound having a carbon-halogen bond, and an alkylamine compound. Examples of the polymerization initiator include phenyl bis(2,4,6-trimethylbenzoyl)phosphine oxide and other polymerization initiators other than phenyl bis(2,4,6-trimethylbenzoyl)phosphine oxide, where one kind of these may be used alone, or two or more kinds thereof may be used in combination.

The content of the polymerization initiator is preferably 1.0% by mass or more and 20.0% by mass or less, 2.0% by mass or more and 17.5% by mass or less, 3.0% by mass or more and 15.0% by mass or less, 4.0% by mass or more and 12.5% by mass or less, or 4.5% by mass or more and 10.0% by mass or less, with respect to the total amount of the ink composition. In a case where the content of the polymerization initiator is within the above-described range, the curability tends to be further improved, and the migration risk tends to be capable of being reduced. Specifically, the content of the polymerization initiator may be 1.0%, 2.0%, 3.0%, 4.0%, 5.0%, 6.0%, 7.0%, 8.0%, 9.0%, 10.0%, 11.0%, 12.0%, 12.5%, 13.0%, 14.0%, 15.0%, 17.5%, or 20.0% by mass, and it may be within a range between any two of these numerical values.

The content of the phenyl bis(2,4,6-trimethylbenzoyl)phosphine oxide is preferably 1.0% by mass or more and 15.0% by mass or less, 1.5% by mass or more and 12.5% by mass or less, 2.0% by mass or more and 10.0% by mass or less, 2.0% by mass or more and 8.0% by mass or less, or 2.5% by mass or more and 7.5% by mass or less, with respect to the total amount of the ink composition. In a case where the content of phenyl bis(2,4,6-trimethylbenzoyl)phosphine oxide is within the above-described range, the migration risk tends to be reduced, and moreover, the curability of the coating film tends to be further improved. Specifically, the content of phenyl bis(2,4,6-trimethylbenzoyl)phosphine oxide may be 1.0, 1.5, 2.0, 2.5, 3.0, 4.0, 5.0, 7.5, 8.0, 10.0, 12.5, or 15.0% by mass with respect to the total amount of the ink composition, or it may be within a range between any two of these numerical values.

The content of the phenyl bis(2,4,6-trimethylbenzoyl)phosphine oxide is preferably 20.0% by mass or more and 80.0% by mass or less, 30.0% by mass or more and 70.0% by mass or less, 35.0% by mass or more and 65.0% by mass or less, 37.5% by mass or more and 62.5% by mass or less, or 40.0% by mass or more and 60.0% by mass or less, with respect to the total amount of the polymerization initiator. In a case where the content of phenyl bis(2,4,6-trimethylbenzoyl)phosphine oxide is within the above-described range, the migration risk tends to be reduced, and moreover, the curability of the coating film tends to be further improved. Specifically, the content of phenyl bis(2,4,6-trimethylbenzoyl)phosphine oxide may be 5.0%, 10.0%, 15.0%, 20.0%, 25.0%, 30.0%, 35.0%, 37.5%, 40.0%, 50.0%, 60.0%, 65.0%, 70.0%, or 80.0% by mass with respect to the total amount of the polymerization initiator, and it may be within a range between any two of these numerical values.

The polymerization initiator according to the present embodiment may contain other polymerization initiators other than phenyl bis(2,4,6-trimethylbenzoyl)phosphine oxide. The other polymerization initiators are not particularly limited. However, examples thereof include 2,4,6-trimethylbenzoyldiphenylphosphine oxide and ethylphenyl(2,4,6-trimethylbenzoyl)phosphinate, which are an acyl phosphine compound.

The content of the other polymerization initiators is preferably 1.0% by mass or more and 15.0% by mass or less, 2.0% by mass or more and 12.5% by mass or less, 3.0% by mass or more and 10.0% by mass or less, or 3.5% by mass or more and 8.5% by mass or less, with respect to the total amount of the ink composition.

The content of the other polymerization initiators is preferably 10.0% by mass or more and 70.0% by mass or less, 15.0% by mass or more and 60.0% by mass or less, 20.0% by mass or more and 55.0% by mass or less, or 30.0% by mass or more and 45.0% by mass or less, with respect to the total amount of the polymerization initiator.

### 1.3.1. Thioxanthone Sensitizing Agent Having Molecular Weight of 300 or More

The ink composition according to the present embodiment contains a thioxanthone sensitizing agent having a molecular weight of 300 or more. The thioxanthone sensitizing agent having a molecular weight of 300 or more includes a thioxanthone structure in the molecule. Regarding the thioxanthone sensitizing agent having a molecular weight of 300 or more, one kind thereof is used alone, or two or more kinds thereof are used in combination.

In a case of being irradiated with actinic rays, the thioxanthone sensitizing agent having a molecular weight of 300 or more absorbs the actinic rays to be in an excited state, and it comes into contact with a photoinitiator to promote the decomposition of the photoinitiator. As a result, the curability of the ink composition can be further improved, and the migration risk of the ink composition can be reduced by further containing a thioxanthone sensitizing agent having a molecular weight of 300 or more.

The thioxanthone sensitizing agent having a molecular weight of 300 or more is not particularly limited; however, it is preferable to include 1,3-di({α-[1-chloro-9-oxo-9H-thioxanthen-4-yl)oxy]acetyl poly[oxy(1-methylethylene)]}oxy)-2,2-bis({α-[1-chloro-9-oxo-9H-thioxanthen-4-yl)oxy]acetyl poly[oxy(1-methylethylene)]}oxymethyl)propane (manufactured by Sartomer Company Inc., Speed Cure (registered trademark) 7010, CAS No.: 1003567-83-6), and alpha-[2-[(9-oxo-9H-thioxanthenyl)oxy]acetyl]-omega-[[2-[(9-oxo-9H-thioxanthenyl)oxy]acetyl]oxy]poly(oxy-1,4-butanediyl) (manufactured by IGM Resins B.V., Omnipol (registered trademark) TX, CAS No.: 813452-37-8).

The molecular weight of the thioxanthone sensitizing agent having a molecular weight of 300 or more is preferably 350 or more, 500 or more, 700 or more, and 1,000 or more. In addition, the molecular weight thereof is preferably 5,000 or less, 4,500 or less, 4,000 or less, or 3,000 or less. In a case where the molecular weight is in the preferred range, the curability and viscosity of the ink composition are excellent. Specifically, the molecular weight may be 300, 350, 500, 600, 700, 800, 900, 1,000, 2,000, 2,500, 3,000, 3,500, 4,000, 4,500, or 5,000, and it may be within a range between any two of these numerical values.

The content of the thioxanthone sensitizing agent having a molecular weight of 300 or more is preferably 0.1% by mass or more and 20% by mass or less, 0.5% by mass or more and 15% by mass or less, 1% by mass or more and 10% by mass or less, 1.5% by mass or more and 8% by mass or less, or 1% by mass or more and 5% by mass or less, with respect to the total amount of the ink composition. In a case where the content thereof is within the above-described range, the viscosity characteristics and curability tend to be more excellent. Specifically, the content of the thioxanthone sensitizing agent having a molecular weight of 300 or more may be 0.1%, 0.3%, 0.5%, 1%, 1.5%, 2%, 3%, 4%, 5%, 6%, 7%, 8%, 9%, 10%, 12.5%, 15%, or 20% by mass, and it may be within a range between any two of these numerical values.

The content of the thioxanthone sensitizing agent having a molecular weight of 300 or more is preferably 10.0% by mass or more and 70.0% by mass or less, 20.0% by mass or more and 60.0% by mass or less, 30.0% by mass or more and 50% by mass or less, or 35.0% by mass or more and 45% by mass or less, with respect to the total amount of phenyl bis(2,4,6-trimethylbenzoyl)phosphine oxide. In a case where the content thereof is within the above-described range, the viscosity characteristics and curability tend to be more excellent. Specifically, the content of the thioxanthone sensitizing agent having a molecular weight of 300 or more may be 10.0%, 15.0%, 20.0%, 25.0%, 30.0%, 35.0%, 40.0%, 45.0%, 50.0%, 55.0%, 60.0%, 65.0%, or 70.0% by mass with respect to the total amount of phenyl bis(2,4,6-trimethylbenzoyl)phosphine oxide, and it may be within a range between any two of these numerical values.

The content of the thioxanthone sensitizing agent having a molecular weight of 300 or more is preferably 5.0% by mass or more and 50.0% by mass or less, 10.0% by mass or more and 40.0% by mass or less, 15.0% by mass or more and 37.5% by mass or less, or 20.0% by mass or more and 35.0% by mass or less, with respect to the total amount of the polymerization initiator. In a case where the content thereof is within the above-described range, the viscosity characteristics and curability tend to be more excellent. Specifically, the content of the thioxanthone sensitizing agent having a molecular weight of 300 or more may be 5.0%, 10.0%, 12.5%, 15.0%, 20.0%, 25.0%, 30.0%, 35.0%, 40.0%, 45.0%, or 50.0% by mass with respect to the total amount of the polymerization initiator, and it may be within a range between any two of these numerical values.

### 1.3.2. Other Sensitizing Agents

The ink composition according to the present embodiment may contain other thioxanthone sensitizing agents (hereinafter, referred to as other sensitizing agents) having a molecular weight of 300 or more. The concept of the other sensitizing agents includes a sensitizing agent that has a molecular weight of less than 300 and a sensitizing agent that does not have a thioxanthone structure.

Examples of the other sensitizing agents include a thioxanthone sensitizing agent having a molecular weight of less than 300, an amine compound (an aliphatic amine, an amine containing an aromatic group, piperidine, a reaction product of an epoxy resin and an amine, triethanolamine triacrylate, or the like), a urea compound (allylthiourea, o-trithiourea, or the like), a sulfur compound (sodium diethyldithiophosphate, a soluble salt of an aromatic sulfinic acid, or the like), a nitrile-based compound (N,N-diethyl-p-aminobenzonitrile or the like), a phosphorus compound (tri-n-butylphosphine, sodium diethyldithiophosphide, or the like), a nitrogen compound (a Michler's ketone, an N-nitrosohydroxylamine derivative, an oxazolidine compound, a tetrahydro-1,3-oxazine compound, a condensation product between formaldehyde or acetaldehyde and a diamine, or the like), and a chlorine compound (carbon tetrachloride, hexachloroethane, or the like).

The other sensitizing agents are preferably 0.1% by mass or more and 20% by mass or less, 0.5% by mass or more and 15% by mass or less, 1% by mass or more and 10% by mass or less, 1.5% by mass or more and 8% by mass or less, or 1% by mass or more and 5% by mass or less, with respect to the total amount of the ink composition. In a case where the content of the other sensitizing agents is within the above-described range, the curability tends to be excellent. Specifically, the content of the difunctional polymerizable compound may be 0.1%, 0.3%, 0.5%, 1%, 1.5%, 2%, 3%, 4%, 5%, 6%, 7%, 8%, 9%, 10%, 12.5%, 15%, or 20% by mass, and it may be within a range between any two of these numerical values.

### 1.4. Polymerization Inhibitor

The ink composition may contain a polymerization inhibitor. The polymerization inhibitor is not particularly limited. However, examples thereof include hydroquinones represented by hydroquinone, hydroquinone monomethyl ether (MEHQ), 1-o-2,3,5-trimethylhydroquinone, and 2-tert-butylhydroquinone; catechols represented by catechol, 4-methylcatechol, and 4-tert-butylcatechol; phenols represented by phenol, butyl hydroxytoluene, butyl hydroxyanisole, p-methoxyphenol, cresol, pyrogallol, 3,5-di-t-butyl-4-hydroxytoluene, 2,2′-methylenebis(4-methyl-6-t-butylphenol), 2,2′-methylenebis(4-ethyl-6-butylphenol), and 4,4′-thiobis(3-methyl-6-t-butylphenol); and hindered amines represented by a compound having a 2,2,6,6-tetramethylpiperidin-N-oxyl skeleton, which is represented by 4-hydroxy-2,2,6,6-tetramethylpiperidinyl-1-oxyl, a compound having a 2,2,6,6-tetramethylpiperidine skeleton, which is represented by 2,2,6,6-tetramethyl-4-hydroxypiperidin-1-oxyl, a compound having a 2,2,6,6-tetramethylpiperidin-N-alkyl skeleton, and a compound having a 2,2,6,6-tetramethylpiperidin-N-acyl skeleton. One kind of these polymerization inhibitors is used alone, or two or more kinds thereof are used in combination.

The content of the polymerization inhibitor is preferably 0.05% by mass or more and 3.0% by mass or less, 0.07% by mass or more and 2.0% by mass or less, or 0.1% by mass or more and 1.0% by mass or less, with respect to the total amount of the ink composition.

### 1.5. Surfactant

The ink composition may contain a surfactant. The surfactant is not particularly limited; however, examples thereof include examples thereof include an acetylene glycol-based surfactant, a fluorine-based surfactant, and a silicone-based surfactant. From the viewpoint of more effectively and reliably exhibiting the action and effect of the present disclosure, the surfactant is preferably a silicone-based surfactant.

The silicone-based surfactant is not particularly limited. However, examples thereof include BYK (registered trademark)-UV3500, UV3570, and BYK350 (product name, BYK JAPAN KK).

The content of the surfactant is not particularly limited with respect to the total amount of the ink composition; however, it is, for example, 0.1% to 1.0% by mass.

### 1.6. Coloring Material

The ink composition according to the present embodiment may contain or may not contain a coloring material. In a case where a coloring material is contained, examples of the coloring material include a dye and a pigment.

The dye is not particularly limited; however, examples thereof include an acidic dye, a direct dye, a reactive dye, and a basic dye. Specific examples of the dyes include Colour Index Generic Name (C. I.) Acid Yellow 17, 23, 42, 44, 79, and 142, C. I. Acid Red 52, 80, 82, 249, 254, and 289, C. I. Acid Blue 9, 45, and 249, C. I. Acid Black 1, 2, 24, and 94, C. I. Food Black 1 and 2, C. I. Direct Yellow 1, 12, 24, 33, 50, 55, 58, 86, 132, 142, 144, and 173, C. I. Direct Red 1, 4, 9, 80, 81, 225, and 227, C. I. Direct Blue 1, 2, 15, 71, 86, 87, 98, 165, 199, and 202, C. I. Direct Black 19, 38, 51, 71, 154, 168, 171, and 195, C. I. Reactive Red 14, 32, 55, 79, and 249, and C. I. Reactive Black 3, 4, and 35. One kind of these dyes is used alone, or two or more kinds thereof are used in combination.

The pigment is not particularly limited; however, examples thereof include an inorganic pigment and an organic pigment. The inorganic pigment is not particularly limited. However, examples thereof include carbon blacks such as furnace black, lamp black, acetylene black, and channel black, iron oxide, and titanium oxide. Examples of the organic pigment include azo pigments such as an insoluble azo pigment, a condensed azo pigment, an azo lake, and a chelate azo pigment, polycyclic pigments such as a phthalocyanine pigment, perylene pigment and perinone pigments, an anthraquinone pigment, a quinacridone pigment, a dioxane pigment, a thioindigo pigment, an isoindolinone pigment, and a quinophthalone pigment, a dye chelate, a dye lake, a nitro pigment, a nitroso pigment, aniline black, and a daylight fluorescent pigment. One kind of these pigments is used alone, or two or more kinds thereof are used in combination.

The carbon black is not particularly limited. However, examples thereof include No. 2300, No. 900, MCF 88, No. 33, No. 40, No. 45, No. 52, MA7, MA8, MA100, and No. 2200 B (all of which are manufactured by Mitsubishi Chemical Corporation), Raven (registered trademark) 5750, Raven 5250, Raven 5000, Raven 3500, Raven 1255, and Raven 700 (all of which are manufactured by Columbia Carbon Inc.), Regal (registered trademark) 400R, Regal 330R, Regal 660R, Mogul L, Monarch 700, Monarch 800, Monarch 880, Monarch (registered trademark) 900, Monarch 1000, Monarch 1100, Monarch 1300, and Monarch 1400 (manufactured by CABOT JAPAN K.K.), Color Black FW1, Color Black FW2, Color Black FW2V, Color Black FW18, Color Black FW200, Color Black S150, Color Black S160, Color Black S170, Printex (registered trademark) 35, Printex U, Printex V, Printex 140U, Special Black 6, Special Black 5, Special Black 4A, and Special Black 4 (all of which are manufactured by Degussa).

The white pigment is not particularly limited; however, examples thereof include C.I. Pigment White 6, 18, and 21.

The yellow pigment is not particularly limited; however, examples thereof include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 155, 167, 172, and 180.

The magenta pigment is not particularly limited; however, examples thereof include C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, and 245, or C.I. Pigment Violet 19, 23, 32, 33, 36, 38, 43, and 50.

The cyan pigment is not particularly limited; however, examples thereof include C.I. Pigment Blue 1, 2, 3, 15, 15:1, 15:2, 15:3, 15:34, 15:4, 16, 18, 22, 25, 60, 65, and 66, and C.I. Vat Blue 4 and 60.

In addition, pigments other than magenta, cyan, and yellow are not particularly limited; however, examples thereof include C. I. Pigment Green 7 and 10, C. I. Pigment Brown 3, 5, 25, and 26, and C. I. Pigment Orange 1, 2, 5, 7, 13, 14, 15, 16, 24, 34, 36, 38, 40, 43, and 63.

The content of the coloring material is not particularly limited with respect to the total amount of the ink composition; however, it is, for example, preferably 1.0% by mass or more and 10.0% by mass or less, or 3.0% by mass or more and 8.0% by mass or less.

Alternatively, the ink composition according to the present embodiment may be a clear ink composition. The clear ink composition is an ink composition that does not contain a coloring material or substantially does not contain a coloring material. In the present embodiment, the phrase “substantially does not contain a coloring material” is not particularly limited; however, for example, the content of the coloring material is preferably 0.50% by mass or less, 0.25% by mass or less, 0.10% by mass or less, 0.05% by mass or less, 0.01% by mass or less, 0.001% by mass or more and 0.500% by mass or less, 0.001% by mass or more and 0.250% by mass or less, 0.001% by mass or more and 0.100% by mass or less, 0.001% by mass or more and 0.050% by mass or less, or 0.001% by mass or more and 0.010% by mass or less, with respect to the total amount of the ink composition.

### 1.7. Other Components

The ink composition according to the present embodiment may contain, in addition to the above-described components, other publicly known components that can be used in the ink composition in the related art. The other components are not particularly limited; however, examples thereof include a slip agent, a dissolution aid, a viscosity adjusting agent, a pH adjusting agent, an antioxidant, a preservative, and a corrosion inhibitor. One kind of these other components is used alone, or two or more kinds thereof are used in combination.

### 2. Method for Producing Ink Composition

A method for producing the ink composition according to the present embodiment is not particularly limited; however, for example, the above-described components may be simultaneously charged into a tank for a mixture and then mixed, or each component may be sequentially charged into a tank for a mixture and then mixed. After mixing each of the components, filtration or degassing may be carried out as necessary.

### 3. Recording Medium

A recording medium that is used for carrying out recording with the ink composition according to the present embodiment is not particularly limited; however, examples thereof include an absorptive recording medium, a low absorptive recording medium, and a non-absorptive recording medium.

The absorptive recording medium is not particularly limited; however, examples thereof include a plain paper, such as an electrophotographic paper having high liquid permeability of an ink composition, an ink jet printing paper (paper for exclusive use for ink jet provided with an ink absorption layer containing silica particles or alumina particles or an ink absorption layer containing a hydrophilic polymer, such as polyvinyl alcohol (PVA) or polyvinyl pyrrolidone (PVP)), cloth, and the like.

The low absorptive recording medium is not particularly limited; however, examples thereof include an art paper, a coated paper, a cast paper, and the like, which have relatively low ink permeability and are used in general offset printing.

The non-absorptive recording medium is not particularly limited. However, examples thereof include a film or a plate of a plastic such as polyvinyl chloride, polyethylene, polypropylene, polyethylene terephthalate (PET), polycarbonate, polystyrene, or polyurethane; a plate of a metal such as iron, silver, copper, or aluminum; or a metal plate which is formed into a film by vapor deposition of these various metals or a plastic film, or a plate of an alloy such as stainless steel or brass; and a recording medium in which a film of a plastic such as polyvinyl chloride, polyethylene, polypropylene, polyethylene terephthalate (PET), polycarbonate, polystyrene, or polyurethane is adhered (coated) to a paper base material.

### 4. Ink Jet Recording Method

An ink jet recording method according to the present embodiment (hereinafter, also simply referred to as a “recording method”) includes an ink adhering step of ejecting the ink composition according to the present embodiment from an ink jet head and adhering the ink composition to a recording medium, and an irradiation step of irradiating the ink composition adhered to the recording medium with actinic rays. The recording method may include, as necessary, other steps such as a transport step of transporting the recording medium.

### 4.1 Ink Adhering Step

In the ink adhering step, the ink composition according to the present embodiment is ejected from an ink jet head and adhered to a recording medium. More specifically, a pressure generating unit provided in the ink jet head is driven to eject, from the nozzle, an ink composition with which a pressure generating chamber of the ink jet head is filled.

Examples of the ink jet head that is used in the ink adhering step include a line head that carries out recording in a line method and a serial head that carries out recording in a serial method.

In the line method using the line head, for example, an ink jet head having a width equal to or larger than a recording width of the recording medium is fixed to the recording apparatus. Then, the recording medium and the ink jet head are relatively moved in the sub-scanning direction (the transport direction of the recording medium, that is, a direction orthogonal to the width direction of the recording medium), and an image is recorded on the recording medium by ejecting ink droplets from the nozzle of the ink jet head in conjunction with the movement.

In the serial method using a serial head, for example, an ink jet head is mounted on a carriage that is movable in a width direction of the recording medium. Then, the carriage is moved along the main scanning direction (the width direction of the recording medium), and an image is recorded on the recording medium by ejecting ink droplets from the nozzle of the ink jet head in conjunction with the movement.

### 4.2. Irradiation Step

In the irradiation step, the ink composition adhered to the recording medium is irradiated with actinic rays. In a case where irradiation is carried out with actinic rays, the polymerization reaction of the polymerizable compound is initiated, whereby the composition is cured, and a coating film is formed. In this case, in a case where a polymerization initiator is present, active species (initiator species) such as a radical, an acid, and a base are generated, and the polymerization reaction of the polymerizable compound is promoted by the function of the initiator species.

Here, examples of the actinic rays include ultraviolet rays, infrared rays, visible light, and X-rays. The radiation source is provided downstream of the ink jet head and irradiates the ink composition. The radiation source is not particularly limited; however, examples thereof include an ultraviolet light emitting diode (UV-LED). By using such a radiation source, it is possible to achieve the miniaturization of the apparatus and the cost reduction. The UV-LED as an ultraviolet light source is small and thus can be attached to the ink jet recording apparatus.

### 4.3. Transport Step

The recording method according to the present embodiment may include a transport step. In the transport step, the recording medium is transported in a predetermined direction in the recording apparatus. More specifically, the recording medium is transported from a paper feeding section of the recording apparatus to a paper discharge section by using a transport roller or a transport belt, which is provided in the recording apparatus. In the transport step, the ink composition ejected from the ink jet head adheres to the recording medium, and a recorded matter is formed. The order or timing of the ink adhering step, the irradiation step, and the transport step is not particularly limited, and for example, the three steps may be carried out at the same time or may be carried out alternately. In addition, two of the three steps may be carried out at the same time, and the remaining step may be carried out separately.

### 5. Recording Apparatus

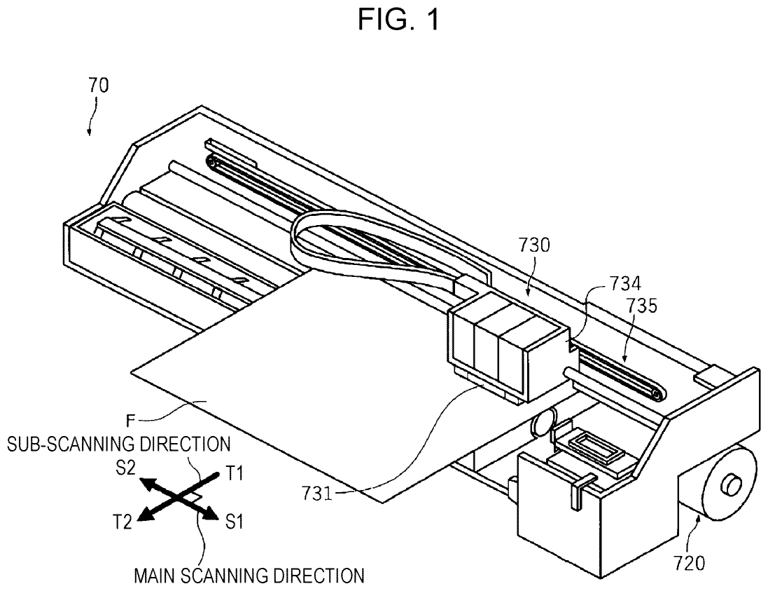

FIG. 1 shows a schematic view of a serial printer as an example of a recording apparatus that is used in the recording method for the ink composition according to the present embodiment. As illustrated in FIG. 1, a serial printer 70 includes a transport section 720 and a recording section 730. The transport section 720 transports a recording medium F fed to the serial printer 70 to the recording section 730 and then discharges the recording medium F after recording to the outside of the serial printer 70. Specifically, the transport section 720 has each feeding roller (not illustrated in the drawing) and transports the recording medium F in a sub-scanning direction T2. It is noted that the serial printer is a printer that adopts an ink jet head arrangement in the serial method described above.

The recording section 730 includes an ink jet head 731, a carriage 734 on which the ink jet head 731 is mounted, and a carriage moving mechanism 735 that moves the carriage 734. Although not illustrated in the drawing, the ink jet head 731 has a plurality of nozzles for ejecting the ink composition to the recording medium F sent from the transport section 720.

Since the serial printer 70 is based on a serial method, the width of the ink jet head 731 is shorter than the width of the recording medium F. The carriage 734 reciprocatively moves in the main scanning directions S1 and S2 together with the ink jet head 731 by the carriage moving mechanism 735. While the ink jet head 731 reciprocatively moves in the main scanning directions S1 and S2, the ink composition is adhered by being ejected from the plurality of nozzles onto the recording medium F. Although not particularly limited, the recording with the ink jet head 731 is carried out in a plurality of passes of two or more passes. It is noted that the pass is also referred to as the main scanning. Sub-scanning for transporting the recording medium F in the sub-scanning direction T2 is carried out between the passes. That is, the main scanning and the sub-scanning are alternately carried out.

In the recording with the ink composition according to the present embodiment, a printer based on the line method described above may be applied in addition to a printer based on the serial method described above. A printer based on the line method is a printer that has a line head which is an ink jet head having a length equal to or longer than a recording width of a recording medium, and a moving mechanism which relatively moves the recording medium and the ink jet head in a direction orthogonal to a width direction of the recording medium, and carries out recording on the recording medium by one scanning.

### EXAMPLES

Hereinafter, the present disclosure will be described in more detail with reference to examples and comparative examples. The present disclosure is not limited by following Examples. In addition, unless otherwise specified, the following operations are carried out at room temperature (25° C.) and under a pressure of 1 atm.

### 1. Preparation of Ink Composition

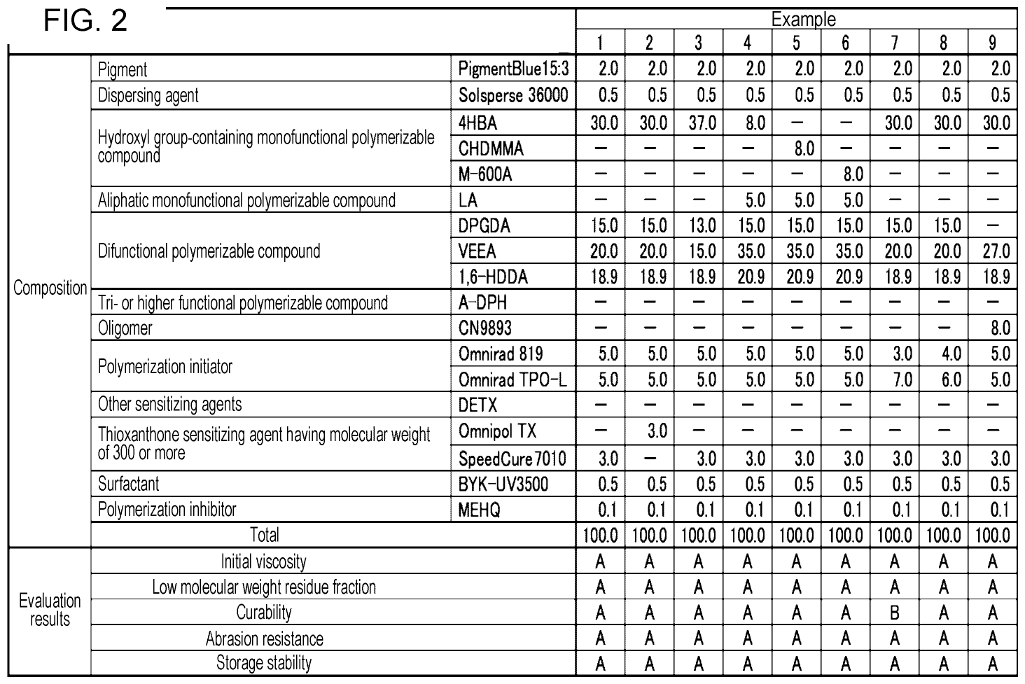

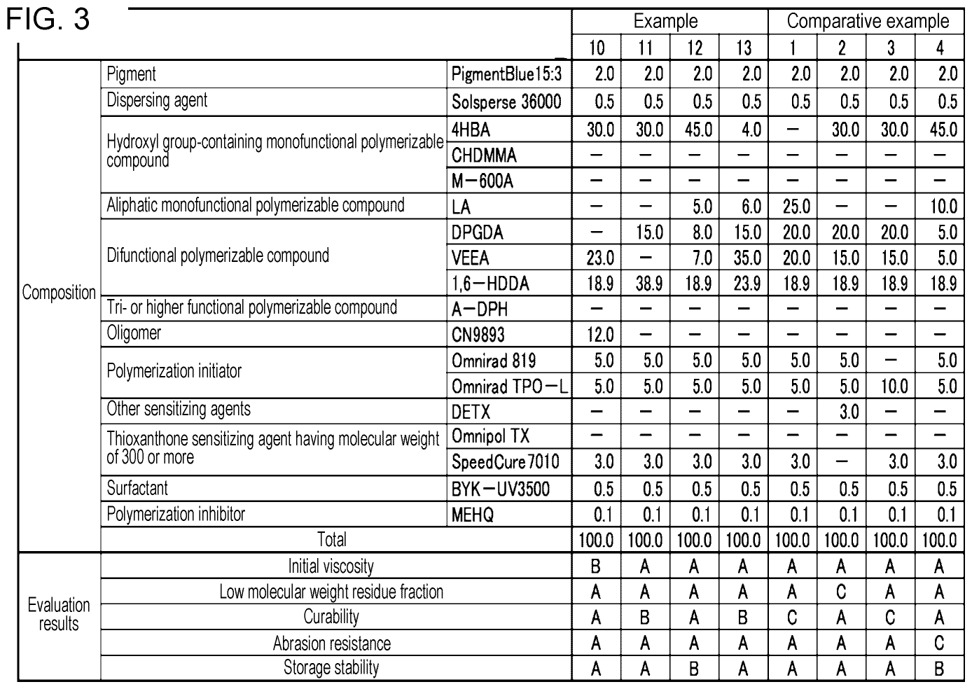

Each component is put into a tank for a mixture, which is a stainless steel container, and mixed and stirred so that the composition described in FIG. 2 and FIG. 3 is obtained, and then filtering is carried out with a 5 μm membrane filter to obtain an ink composition of each of examples and comparative examples. It is noted that the numerical values of the respective components shown in the respective examples in the figure are indicated in terms of % by mass unless otherwise specified.

The abbreviations and the components of the product, which are used in FIG. 2 and FIG. 3, are as follows. It is noted that, in each of the columns in FIG. 2 and FIG. 3, the notation of “-” indicates that the corresponding component is not used.
4-HBA (manufactured by Osaka Organic Chemical Industry Ltd., 4-hydroxybutyl acrylate)
CHDMM (product name “CHDMMA”, manufactured by Mitsubishi Chemical Corporation, 1,4-cyclohexanedimethanol monoacrylate)
M-600A (product name “Epoxy Ester M-600A”, manufactured by Kyoeisha Chemical Co., Ltd., 2-hydroxy-3-phenoxypropyl (meth)acrylate)
LA (manufactured by Osaka Organic Chemical Industry Ltd., lauryl acrylate)
DPGDA (product name “MIRAMER M222”, manufactured by MIWON Specialty Chemical Co., Ltd., dipropylene glycol diacrylate)
VEEA (manufactured by Nippon Shokubai Co., Ltd., acrylic acid 2-(2-vinyloxyethoxy)ethyl ester)
1,6-HDDA (manufactured by Osaka Organic Chemical Industry Ltd., 1,6-hexanediol diacrylate)
A-DPH (manufactured by SHIN-NAKAMURA CHEMICAL Co., Ltd., dipentaerythritol hexaacrylate)
CN9893 (manufactured by Sartomer Company Inc., difunctional urethane acrylate oligomer)
Omnirad 819 (manufactured by IGM Resins B.V., phenyl bis(2,4,6-trimethylbenzoyl)phosphine oxide)⋅PEA (product name “VISCOAT #192”, manufactured by Osaka Organic Chemical Industry Ltd., phenoxyethyl acrylate)
Omnirad TPO-L (manufactured by IGM Resins B.V., ethyl phenyl(2,4,6-trimethylbenzoyl)phosphinate
Speedcure DETX (manufactured by Sartomer Company Inc., 2,4-diethylthioxanthone)
Omnipol TX (manufactured by IGM Resins B.V., alpha-[2-[(9-oxo-9H-thioxanthenyl)oxy]acetyl]-omega-[[2-[(9-oxo-9H-thioxanthenyl)oxy]acetyl]oxy]poly(oxy-1,4-butanediyl) (CAS: 813452-37-8))
Speedcure 7010 (manufactured by Sartomer Company Inc., 1,3-di({α-[1-chloro-9-oxo-9H-thioxanthen-4-yl)oxy]acetyl poly[oxy(1-methylethylene)]}oxy)-2,2-bis({α-[1-methylethylene]}oxymethyl)propane (CAS: 1003567-83-6))
BYK-UV3500 (manufactured by BYK Additives & Instruments, a polyether-modified polydimethylsiloxane having an acryloyl group)
MEHQ (product name “p-methoxyphenol”, manufactured by Kanto Chemical Co., Inc., hydroquinone monomethyl ether)

### 2. Evaluation Method

### 2.1. Initial Viscosity

Using a rotational viscometer (product name “Rheometer MCR-301”, manufactured by Anton Paar GmbH), the initial viscosity of the ink composition of each of examples and comparative examples immediately after preparation is measured at room temperature (25° C.) based on JIS Z 8803. The initial viscosity is evaluated according to the following evaluation standards, and the results thereof are shown in FIG. 2 and FIG. 3.

### Evaluation Standards

A: The viscosity is 20 mPa-s or more and 22 mPa-s or less.
B: The viscosity is more than 19 mPa-s and less than 20 mPa-s, or more than 22 mPa-s and less than 23 mPa-s.
C: The viscosity is 19 mPa-s or less, or 23 mPa-s or more

### 2.2. Low Molecular Weight Residue

As one indicator of the risk of migration, the amount of the low molecular weight residue fraction of the cured coating film of the ink composition was investigated. Specifically, each ink composition is applied onto a polyester film with a bar coater so that the coating thickness is 10 μm, and then the ink composition is irradiated with ultraviolet rays at 1,000 mJ/cm². In this case, as the ultraviolet light source, a UV-LED having a peak wavelength of 395 nm is used. Then, immersion is carried out together with the polyester film at each level in tetrahydrofuran (THF) for one week, and the extract in THF is analyzed by liquid chromatography mass spectrometry (LC/MS) to quantify the residual sensitizing agent having a molecular weight of 300 or less, and the extraction rate in the entire coating film is calculated. The extraction rate was evaluated according to the following evaluation standards, and the results thereof are shown in FIG. 2 and FIG. 3. It can be said that the lower the extraction rate, the lower the migration risk.

### Evaluation Standards

A: Extraction rate is less than 1%.
B: Extraction rate is 1% or more and less than 2%.
C: Extraction rate is 2% or more

### 2.3. Curability

As an indicator of the curability of the ink composition, the evaluation of the cotton swab load tackiness is carried out. Specifically, each ink composition is applied onto a recording medium made of polyvinyl chloride with a bar coater so that the coating thickness is 10 μm, and the coating film is irradiated with ultraviolet rays at a speed of 0.04 cm/sec. In this case, as the ultraviolet light source, a UV-LED having a peak wavelength of 395 nm is used. In addition, the irradiation energy of the ultraviolet rays is stepwisely increased, the surface of the coating film is rubbed with a cotton swab, and the irradiation energy at which the cotton swab is not colored is recorded. The curability is evaluated according to the evaluation standards below, and the results thereof are shown in FIG. 2 and FIG. 3.

### Evaluation Standards

A: The irradiation energy at which the cotton swab is not colored is less than 500 mJ/cm².
B: The irradiation energy at which the cotton swab is not colored is 500 mJ/cm² or more and less than 700 mJ/cm².
C: The irradiation energy at which the cotton swab is not colored is 700 mJ/cm² or more

### 2.4. Abrasion Resistance

Each ink composition is subjected to an evaluation of abrasion resistance. Specifically, first, in the same manner as in the evaluation of the cotton swab load tackiness described above, a coating film having a thickness of 8 μm is prepared, where the coating film is cured to a tack free state which is a state in which the cotton swab is not colored. Next, in accordance with JIS K 5701 (ISO 11628) (which specifies the method for testing inks, paint samples, and printed matter which are used in planographic printing), each coating film is subjected to an abrasion resistance test by using a Gakushin-type tester for abrasion fastness to rubbing (manufactured by TESTER SANGYO CO., LTD.). Specifically, a high-quality paper is placed on a surface of a coating film that is shredded in a strip shape to have a predetermined size, rubbed by applying a load of 500 g, and then a state of the stains due to the coloring of the high-quality paper after rubbing and a state of the coating film are visually observed. The evaluation is carried out according to the following evaluation standards, and the results thereof are shown in FIG. 2 and FIG. 3.

### Evaluation Standards

A: There are no stains on the high-quality paper, and there is no peeling-off or scratching on the recording surface.
B: There are stains on the high-quality paper, and there is no peeling-off or scratching on the recording surface.
C: There are stains on the high-quality paper, and peeling-off or scratching is observed on the recording surface

### 2.5. High-Temperature Storage Stability

Each ink composition, of which the initial viscosity is measured, is subjected to the measurement of the post-storage viscosity after storing at 70° C. for 8 days as an indicator of storage stability. It is noted that each ink composition is put into a sealable glass bottle and then stored. The rate of increase in viscosity for the post-storage viscosity with respect to the initial viscosity is calculated and evaluated according to the following evaluation standards, and the results thereof are shown in FIG. 2 and FIG. 3.

### Evaluation Standards

A: The rate of increase in viscosity is less than 5%.
B: The rate of increase in viscosity is 5% or more and less than 10%.
C: The rate of increase in viscosity is 10% or more

### 3. Summary of Evaluation Results

It is shown that, as shown in FIG. 2 and FIG. 3, the ink compositions of Examples 1 to Example 13 have excellent curability of the ink composition and excellent abrasion resistance of the coating film while reducing the migration risk. On the other hand, it is found that the ink compositions of Comparative Example 1 to Comparative Example 4 are difficult to improve any of the migration risk, the curability, or the abrasion resistance.

What is claimed is:

1. A radiation curable ink composition for ink jet, comprising:
a polymerizable compound;
a polymerization initiator; and
a thioxanthone sensitizing agent having a molecular weight of 300 or more, wherein
the polymerizable compound includes a monofunctional polymerizable compound and a difunctional polymerizable compound,
the polymerization initiator includes phenyl bis(2,4,6-trimethylbenzoyl)phosphine oxide,
the monofunctional polymerizable compound includes a hydroxyl group-containing monofunctional polymerizable compound, and
a content of the difunctional polymerizable compound is 30% by mass or more with respect to a total amount of the ink composition.

2. The radiation curable ink composition for ink jet according to claim 1, wherein
a content of the hydroxyl group-containing monofunctional polymerizable compound is 5% by mass or more and 40% by mass or less with respect to the total amount of the ink composition.

3. The radiation curable ink composition for ink jet according to claim 1, wherein
the hydroxyl group-containing monofunctional polymerizable compound includes one or more compounds selected from 4-hydroxybutyl acrylate, 1,4-cyclohexanedimethanol monoacrylate, and 2-hydroxy-3-phenoxypropyl (meth)acrylate.

4. The radiation curable ink composition for ink jet according to claim 1, wherein
the radiation curable ink composition for ink jet does not contain an oligomer or contain the oligomer, and
when the radiation curable ink composition for ink jet contains the oligomer, a content of the oligomer is 9% by mass or less with respect to the total amount of the ink composition.

5. The radiation curable ink composition for ink jet according to claim 1, wherein
a content of the phenyl bis(2,4,6-trimethylbenzoyl)phosphine oxide is 1% by mass or more with respect to the total amount of the ink jet composition.

6. The radiation curable ink composition for ink jet according to claim 1, wherein
the thioxanthone sensitizing agent includes one or more compounds selected from 1,3-di({α-[1-chloro-9-oxo-9H-thioxanthen-4-yl)oxy]acetyl poly[oxy(1-methylethylene)]}oxy)-2,2-bis({α-[1-chloro-9-oxo-9H-thioxanthen-4-yl)oxy]acetyl poly[oxy(1-methylethylene)]}oxymethyl)propane and alpha-[2-[(9-oxo-9H-thioxanthenyl)oxy]acetyl]-omega-[[2-[(9-oxo-9H-thioxanthenyl)oxy]acetyl]oxy]poly(oxy-1,4-butanediyl).

7. The radiation curable ink composition for ink jet according to claim 1, wherein
the radiation curable ink composition for ink jet contains one or more compounds selected from dipropylene glycol diacrylate, acrylic acid 2-(2-vinyloxyethoxy)ethyl ester, and 1,6-hexanediol diacrylate.

8. The radiation curable ink composition for ink jet according to claim 1, wherein
a content of the monofunctional polymerizable compound is 10% by mass or more and 50% by mass or less with respect to the total amount of the ink composition.

9. An ink jet recording method comprising:
an ejection step of ejecting the radiation curable ink composition for ink jet according to claim 1.
